(19) United States
(12) Patent Application Publication
(10) Pub. No.: US 2006/0048056 A1
(43) Pub. Date: Mar. 2, 2006

(54) Motion menu generation method and system

(76) Inventor: Chang-Shun Huang, Taipei (TW)

Correspondence Address: BIRCH STEWART KOLASCH & BIRCH, PO BOX 747, FALLS CHURCH, VA, 22040-0747, US

(21) Appl. No.: 10/928,138

(22) Filed: Aug. 30, 2004

(51) Int. Cl. G06F 17/00; G06F 9/00

(52) U.S. Cl. 715/719; 715/730; 715/731

(57) ABSTRACT

A motion menu generation method, implemented by a motion menu generation system. First, menu foreground elements are provided, and at least one still image is retrieved as an input of the motion menu generation system. Next, an animated image and animated image presentation data for presenting the animated image are generated from the still image. A motion menu conforming to a media format is generated. The motion menu comprises the menu foreground elements and a background for displaying the animated image according to the animated image presentation data. A stand-alone device dedicated to playing media can playback the motion menu according to the media format.

### BACKGROUND

The present invention relates to media navigation menus, and in particular, to a motion menu generation method.

The Digital Versatile Disc/Disk (DVD) specification supports animated menu backgrounds. DVD menu authoring applications increasingly support motion menu background authoring functionality, enabling import of video as a menu background. Customized menu backgrounds can thus be achieved. Nevertheless, no video library is provided with this functionality. Importing video as a menu background consumes excessive memory capacity. Further, it is more difficult for amateurs to capture video than it is to take good photos. Good photos are accordingly much more popular. Additionally, digital photos may bring high resolution with less memory capacity consumption than digital video. Conventional DVD menu authoring applications, however, do not provide functionality for converting still images into animated backgrounds for DVD motion menus.

Hence, there is a need for a new motion menu authoring utility providing the aforementioned functionality.

### SUMMARY

Accordingly, an embodiment of the invention provides a motion menu generation method, implemented by a motion menu generation system. First, menu foreground elements are provided, and at least one still image is retrieved as an input of the motion menu generation system. Next, an animated image and animated image presentation data for presenting the animated image are generated from the still image. A motion menu conforming to a media format is generated. The motion menu comprises the menu foreground elements and a background for displaying the animated image according to the animated image presentation data. A stand-alone device dedicated to playing media can play the motion menu according to the media format.

Additionally, the motion menu generation method of the invention can be implemented with a computer application recorded in a storage medium such as a memory or a memory device. The computer application, when loaded into a computer, directs the computer to execute the motion menu generation method of an embodiment of the invention.

Additionally, an embodiment of the invention provides a motion menu generation system comprising a foreground authoring module, a background authoring module, and a menu generation module. The foreground authoring module provides menu foreground elements. The background authoring module retrieves at least one still image, generates an animated image from the still image, and generates animated image presentation data for presenting the animated image. The menu generation module generates a motion menu comprising the menu foreground elements and a background for displaying the animated image according to the animated image presentation data. The motion menu conforming to a media format by which a stand-alone device dedicated to playing media can play the motion menu.

### DESCRIPTION OF THE DRAWINGS

An embodiment of the invention can be more fully understood by reading the subsequent detailed description and examples with references made to the accompanying drawings, wherein:

FIG. 1 is a block diagram of the configuration of a motion menu generation system 9 of an embodiment of the invention;

FIG. 2 is a block diagram of a computing device 10 of an embodiment of the invention;

FIG. 3 is a flowchart of a motion menu generation method according to an embodiment of the invention;

FIG. 4 is a schematic diagram of motion menu generation steps;

FIG. 5 is a flowchart of step S12 in detail according to an embodiment of the invention;

FIG. 6 is a schematic diagram of animated image presentation data 61 of an embodiment of the invention;

FIG. 7 is a schematic diagram of a media playback system in an embodiment of the invention; and

FIG. 8 is a schematic diagram of the storage medium according to an embodiment of the invention.

### DETAILED DESCRIPTION

U.S. patent application Ser. No. 10/866,665 entitled “Disc content generation method and system” discloses a method for generating a motion menu from still images. An embodiment of the invention provides a motion menu generation method for generating the motion menu background utilizing still images. The motion menu generation method may be implemented by a computer program executed in a computing device, such as a personal computer, or a laptop computer for example.

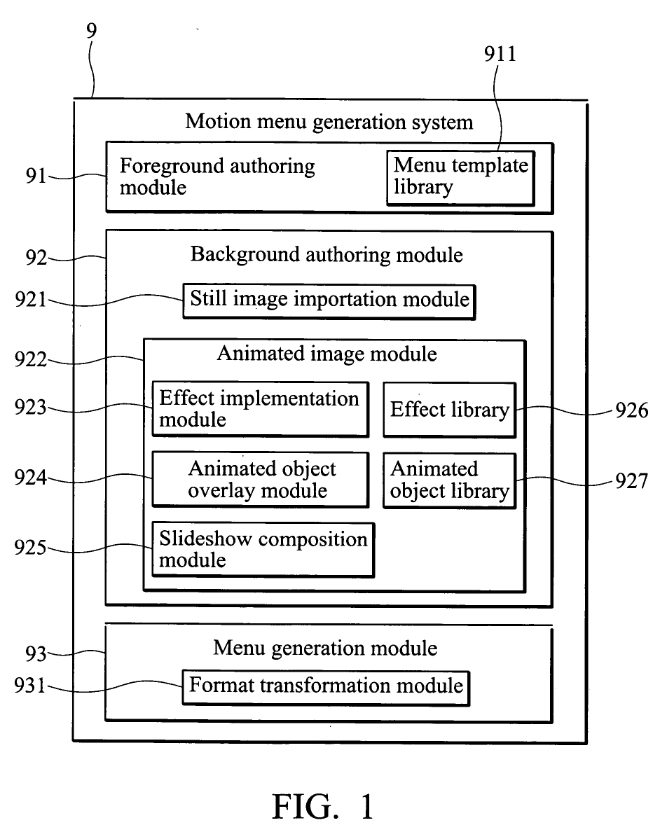

FIG. 1 is a block diagram of the configuration of a motion menu generation system 9 in an embodiment of the invention. Motion menu generation system 9 comprises foreground authoring module 91, background authoring module 92 and menu generation module 93. Foreground authoring module 91 provides functions for authoring and generating menu elements in menu foregrounds. Foreground authoring module 91 may comprise a menu template library 911 storing menu templates. Each menu template comprises menu foreground elements in a specific configuration. The menu foreground elements may comprise text, scene buttons, other buttons, and other as yet developed control elements existing on menu foregrounds. Menu template and authoring method thereof may be detailed with reference to the U.S. patent application Ser. No. 10/874,285 providing a multimedia authoring method using theme templates.

Background authoring module 92 provides functions for authoring and generating motion menu backgrounds. Background authoring module 92 receives still images, generates animated images from the received still images, and outputs animated image presentation data for presenting the animated images. The animated image presentation data generated by background authoring module 92 may be in a video data format or in other formats, such as animated Graphics Interchange Format (GIF) images, or Flash™ (Macromedia Inc.) files for example. The input still images may comprise bit-mapped graphics or vector graphics. When generated in image objects plus presentation code stating the way to present the image objects, the animated image presentation data may achieve advantages of low memory capacity and high image resolution. Background authoring module 92 may comprise still image importation module 921 retrieving still images and animated image module 922 generating animated image presentation data. Animated image module 922 may further comprise effect implementation module 923, animated object overlay module 924, slideshow composition module 925, effect library 926, and animated object library 927. Effect implementation module 923 implements image effects on still images for generating animated images. Animated object overlay module 924 overlays animated objects on still images for generating animated images. Slideshow composition module 925 composes slideshows utilizing still images and transition effects. Effect library 926 stores and provides image effects and transition effects. Animated object library 927 stores and provides animated objects.

Menu generation module 93 generates a motion menu comprising a foreground and a background, respectively presenting the menu foreground elements and the animated image, generated by foreground authoring module 91 and background authoring module 92. Menu generation module 93 may comprise format transformation module 931. Format transformation module 931 transforms generated motion menus and animated image presentation data to conform to a disc format, such as DVD, Blu-ray, Advanced Optical Disc (AOD), Enhanced Versatile Disc (EVD), High-Definition DVD (HDDVD), or other as yet defined media formats.

The motion menu generation system 9 can be implemented by a computer application.

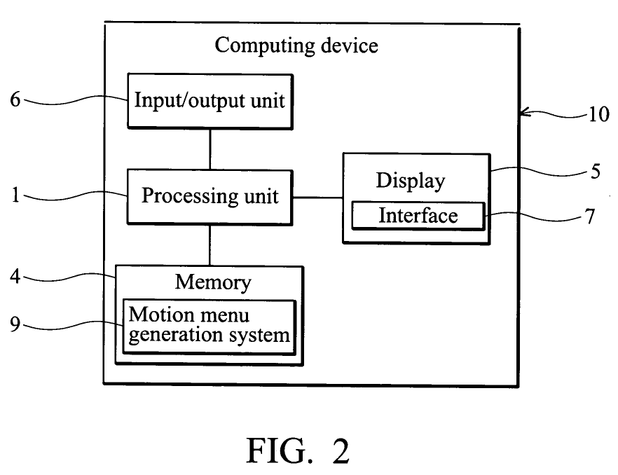

FIG. 2 shows a block diagram of a computing device 10 in an embodiment of the invention. Computing device 10 comprises processing unit 1 for processing data, memory 4 for storing data, display 5 for displaying a user interface, and an input/output unit 6 for data input and output. Processing unit 1 couples to memory 4, display 5, and input/output unit 6. In an embodiment of the invention, memory 4 comprises a motion menu generation system 9.

Motion menu generation system 9 directs computing device 10 to perform a motion menu generation method.

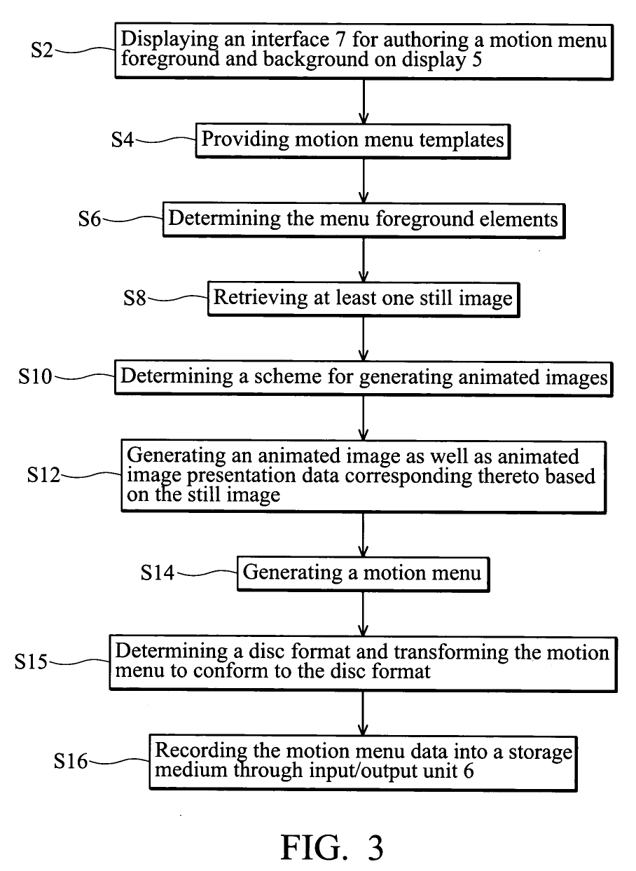

FIG. 3 is a flowchart of a motion menu generation method according to an embodiment of the invention.

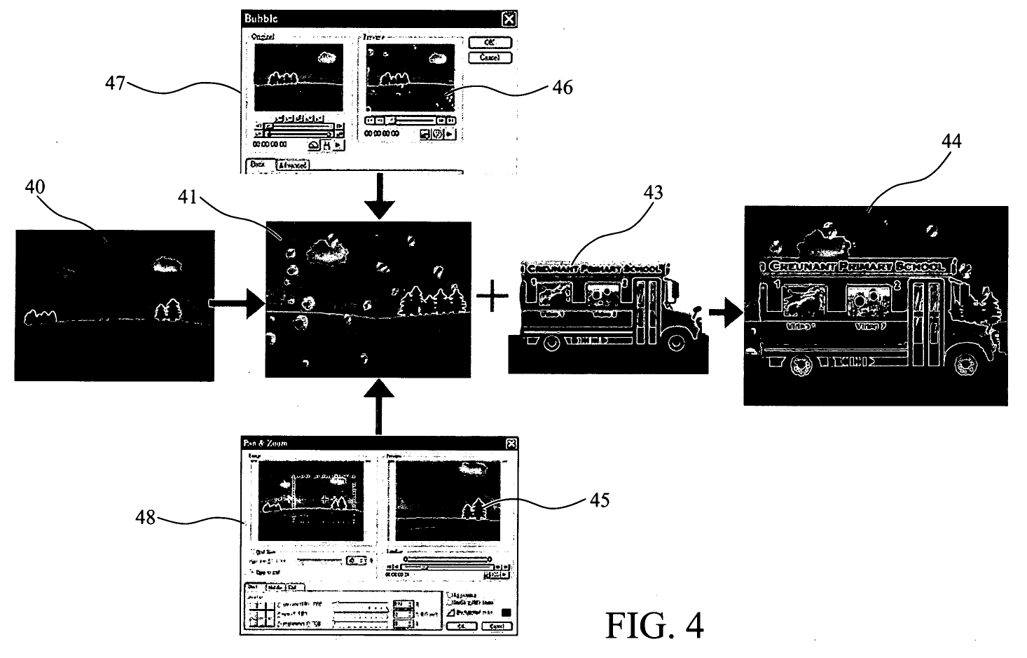

Processing unit 1 displays an interface 7 for authoring a motion menu foreground and background on display 5 (step S2). Processing unit 1 provides motion menu templates included in menu template library 911 utilizing foreground authoring module 91 (step S4). Each motion menu template comprises menu foreground elements, such as text or buttons, for media content navigation. When a menu template is determined according to user operation, menu foreground elements of the menu template may be further adjusted. When menu foreground element authoring is complete, processing unit 1 determines the menu foreground elements to be presented in a subsequently generated motion menu foreground, such as foreground 43 in FIG. 4 (step S6). Processing unit 1 is then directed by background authoring module 92 to perform the following steps.

FIG. 4 is a schematic diagram of motion menu generation steps.

With reference to FIG. 3 and FIG. 4, processing unit 1 retrieves at least one still image, such as image 40, utilizing still image importation module 921 (step S8). A user selects an automatic or customized scheme for generating a motion menu and the background thereof. Processing unit 1 determines the selected scheme (step S10) and proceeds to steps S12 and S14. If an automatic motion menu generation scheme is selected, processing unit 1 may perform steps S12 and S14 automatically. If a customized motion menu generation scheme is selected, processing unit 1 may perform steps S12 and S14 progressively to interact with user operation and settings adjustment.

In step S12, processing unit 1 generates an animated image (such as animated image 41) as well as animated image presentation data corresponding thereto based on the at least one still image (such as image 40) utilizing animated image module 922 (step S12).

In step S14, processing unit 1 generates a motion menu (such as motion menu 44) utilizing menu generation module 93 (step S14). The generated motion menu comprises the menu foreground elements (such as foreground 43) and a background for displaying the animated image (such as animated image 41) according to the animated image presentation data, wherein the menu foreground elements and the animated image are respectively determined and generated in step S6 and step S12.

Processing unit 1 directed by format transformation module 931 determines a disc format and transforms the motion menu to the disc format, such as DVD, Blu-ray, AOD, HDDVD, EVD, or other media format. (step S15). Processing unit 1 then records the motion menu data into a storage medium through input/output unit 6 (step S16). For example, the input/output unit 6 is a disc recording device writing the generated motion menu into a disc conforming to DVD, Blu-ray, AOD, HDDVD, EVD, or other media formats. The generated motion menu data comprises the animated image presentation data. The animated image presentation data may be generated and recorded in video data formats comprising image sequences, or other formats, such as image objects plus presentation code. The data of the generated motion menu may be transformed to other media formats described later. The image sequences may comprise, for example, animated GIF, Audio Video Interleave (AVI) files, or MPEG-4 files.

The order of foreground and background authoring is described by way of example and is not intended to limit the invention. The order of foreground and background authoring may be conversed or changed variously.

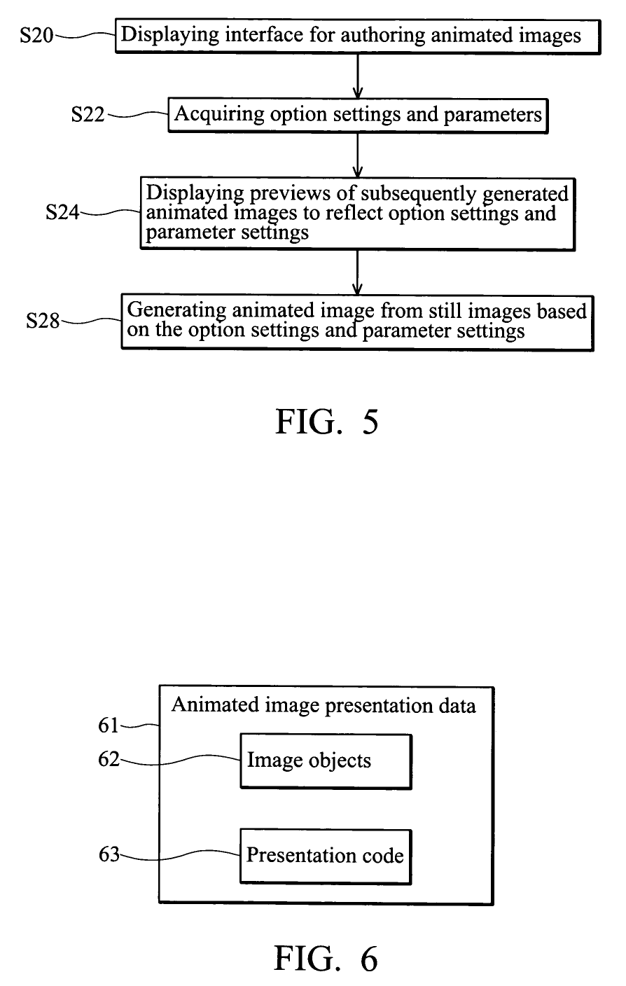

Various methods may be adopted to generate animated images from still images. For example, methods of generating animated images by implementing image effects, combining animated objects, and by composing slideshows may be utilized, wherein processing unit 1 may generate animated images in step S12 utilizing at least the effect implementation module 923, animated object overlay module 924, or slideshow composition module 925 respectively. The step S12 is described in detail with reference to FIG. 4 and FIG. 5.

FIG. 5 is a flowchart of step S12 in detail according to an embodiment of the invention.

When determining that a customized motion menu generation scheme has been selected (step S10 in FIG. 3), processing unit 1 displays an interface for authoring animated images, comprising options for adjusting settings and parameters required in generating animated image presentation data (step S20). Option settings correspond to parameters which may be provided by the manufacturer of motion menu generation system 9. Setting options may comprise the options for selecting methods for generating animated image from still images, options for selecting image effects, animated objects, transition effects, and options for selecting attributes of image effects, animated objects, and transition effects. Generation of animated images can be configured by selecting setting options and/or by fine turning parameters via input/output unit 6. Processing unit 1 acquires option and parameter settings required by step S28 (step S22).

For example, a method of generating an animated image from still image 40 by implementing image effects is selected. Bubble, pan and zoom effects are selected for application to image 40. Interface 47 and 48 in FIG. 4 are presented on display 5 for selecting setting options and adjusting parameters of the bubble and pan and zoom effects.

Processing unit 1 may display previews (such as preview 45 and 46) of subsequently generated animated images to reflect option settings and parameter settings (step S24).

After settings options and parameters are determined according to user preference, processing unit 1 generates animated image (such as animated image 41) from a still image (such as image 40) based on the option settings and parameters settings (step S28). For example, processing unit 1 directed by effect implementation module 923 generates animated image 41 from image 40 based option settings and parameter settings of the bubble, pan and zoom effects. Animated image 41 simulates motion on image 40 with bubbles floating upward.

When determining an automatic motion menu generation scheme has been selected (step S10 in FIG. 3), processing unit 1 generates animated images and motion menus according to randomly, or dynamically derived parameters, or predetermined parameters. These parameters may comprise methods, image effects, animated objects, transition effects, and attributes thereof for generating animated images from still images.

Similarly, animated images may be generated by implementing other image effects on still images. For example, effect library 926 may provide numerous image effects for selection and application, including but not limited to Oil Paint, Light, Colored Pen, Bubble, Brightness & Contrast, Pan & Zoom, Star, Water Color, Diffuse Glow, Zoom Motion, Lens Flare, Charcoal, Mosaic, and other effects provided by image editing software packages. Exemplary image editing software packages on the market include Ulead PhotoImpact, Ulead Media Studio, and Ulead Picture Show. Effect implementation module 923 may animate a still image by continuously activating certain attributes of one or more image effects implemented on the still image or a portion thereof. For example, motion is simulated by continuous brightness adjustment, continuously changing the level of distort effects.

Animated object overlay module 924 may derive animated image by combining animated objects with still images. Animated objects may be combined with still images in various ways. An animated object may move relative to a still image or be fixed to a portion thereof. The animated object may comprise 2-dimensional objects, 3-dimensional objects, and video objects stored in animated object library 927. 2-dimensional objects may comprise animated GIFs, Flash files, an image moving relative to a combined still image, or others. 3-dimensional objects may comprise virtual-reality objects. 3-dimensional objects may attach a still image as a surface texture thereof. Video objects may comprise frames of an animated object without backgrounds.

Slideshow composition module 925 may derive the animated image as a slideshow from still images associated with transition effects. Various transition effects may be utilized in composing slideshows, such as flow, cross-fade, 3-dimensional fly and circle transition effects.

Effects implementation, animated object combination, slideshow composition, and other methods may be combined to generate various animated images.

In step S16 of FIG. 3, motion menu data comprising animated image presentation data is recorded on a disc. Animated image presentation data may be formed in image sequences, video format, or image objects plus presentation code, as illustrated in FIG. 6.

FIG. 6 is a schematic diagram of animated image presentation data 61 in an embodiment of the invention. Animated image presentation data 61 comprises image objects 62 and presentation code 63. Image objects 62 may comprise still images, and/or animated objects. Presentation code 63 describes the way image objects 62 are displayed and may comprise markup languages, metadata, and/or programming languages.

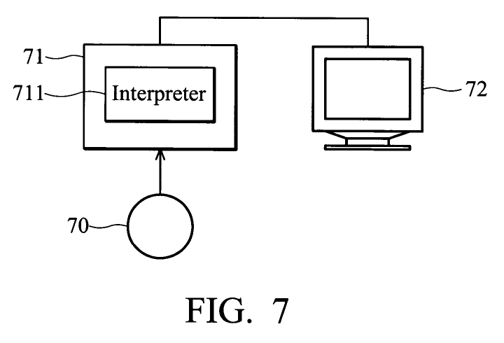

FIG. 7 is a schematic diagram of a media play system in an embodiment of the invention. FIG. 7 comprises storage medium 70, a media player 71, and a display 72 connected to media player 71. Media player 71 may be a stand-alone disc player, such as DVD player, or other device dedicated to media playback. Media player 71 may comprises interpreter 711 for presenting animated images by decoding image objects 62 and presentation code 63. Storage medium 70 may be any internal or external storage medium of and readable by media player 71, such as a DVD disc, an AOD disc, a HDDVD disc, a Blu-ray disc, an EVD disc, a tape, a floppy disk, a hard disk, and others. Animated image presentation data 61 and motion menu data may be generated to conform to various media formats. The media formats in an embodiment of the invention enable a stand-alone media playback device (such as media player 71) conforming thereto to play animated image presentation data and motion menu data of the media formats.

For example, if animated image presentation data 61 represents animated image 41, image objects 62 may comprise image 40, and presentation code 63 may comprise the parameter settings of bubble, pan, and zoom effects. Animated image presentation data 61 and data of motion menu 44 conforming to a media format are recorded into storage medium 70 in step S16 of FIG. 3. When reading storage medium 70, media player 71 presents animated image 41 on display 72 by decoding the animated image presentation data 61 according to the media format. Specifically, interpreter 711 of media player 71 displays image objects 62 according to presentation code 63. Similarly, parameter settings of other effects may be stored in presentation code 63.

For example, animated image presentation data 61 represents a second animated image and is recorded in storage medium 70. Image objects 62 comprise a still image, and presentation code 63 comprise metadata, such as Exchangeable Image File (EXIF), storing attributes on the still image such as shutter speed, exposure compensation, F number, what metering system was used, if a flash was used, date and time the still image was taken, whitebalance, auxiliary lenses that were used, and resolution. When reading storage medium 70, interpreter 711 of media player 71 displays and varies image objects 62 with respect to at least one attribute stored in presentation code 63 to present the second animated image. For example, interpreter 711 retrieves the metadata in presentation code 63 as initial values of various attributes of effects and filters applied to the still image, and animates the still image by continuously varying the various attributes of the effects and filters.

For example, animated image presentation data 61 represents a third animated image and is recorded in storage medium 70. Image objects 62 comprise still images and animated objects, and presentation code 63 comprises markup languages, such as extensible markup language (XML), describing interaction of the still images and the animated objects. When reading storage medium 70, interpreter 711 of media player 71 displays image objects 62 according to the markup languages describing the interaction stored in presentation code 63 to present the third animated image.

For example, animated image presentation data 61 represents a slideshow and is recorded in storage medium 70. Image objects 62 comprise still images forming the slideshow, and presentation code 63 comprises parameters of transition effects and describes organization of the still images. When reading storage medium 70, interpreter 711 of media player 71 displays image objects 62 according to presentation code 63 to present the slideshow.

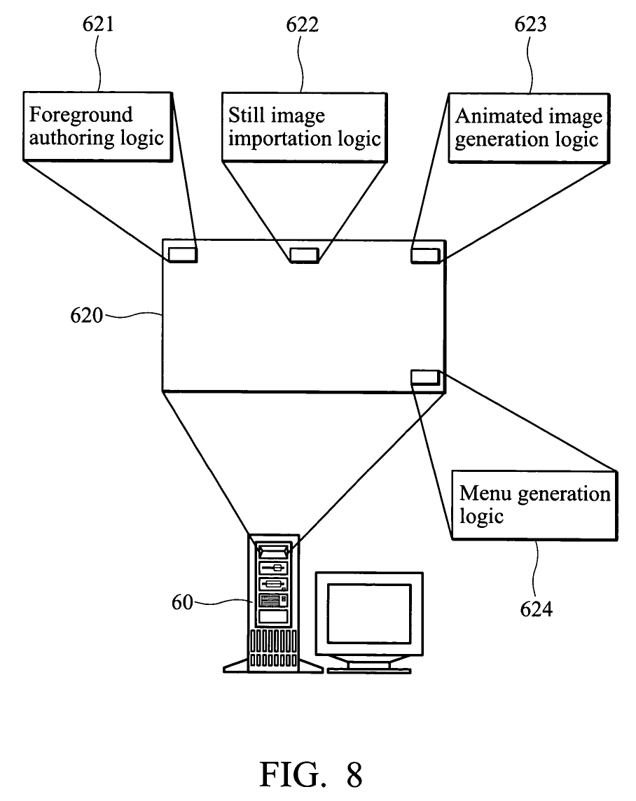

FIG. 8 is a schematic diagram of the storage medium according to an embodiment of the invention. Storage medium 60 stores a computer program 620 for implementing the motion menu generation method of the invention. The computer program 620 comprises foreground authoring logic 621, still image importation logic 622, animated image generation logic 623, and menu generation logic 624.

Foreground authoring logic 621 provides functions for authoring and generating menu foreground elements in menu foregrounds. Still image importation logic 622 receives still images. Animated image generation logic 623 generates animated images from the received still images, and outputs animated image presentation data for presenting the animated images. Animated image generation logic 623 further provides functions for generating animated images by implementing image effects, overlaying animated objects, and composing slideshows with still images and transition effects. Menu generation logic 624 generates a motion menu comprising a foreground and a background, respectively presenting the menu foreground elements and the animated image.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motion menu generation method, implemented in a motion menu generation system, comprising the steps of:
providing menu foreground elements;
retrieving at least one still image as an input of the motion menu generation system;
generating an animated image from the still image and animated image presentation data for presenting the animated image; and
generating a motion menu comprising the menu foreground elements and a background for displaying the animated image according to the animated image presentation data, wherein the motion menu conforming to a media format.

2. The method as claimed in claim 1, wherein the animated image implements at least one image effect on the still image.

3. The method as claimed in claim 2, wherein the image effect comprises at least a Oil Paint, Light, Colored Pen, Bubble, Brightness & Contrast, Pan & Zoom, Star, Water Color, Diffuse Glow, Zoom Motion, Lens Flare, Charcoal, or a Mosaic effect.

4. The method as claimed in claim 1, wherein the animated image is derived by combining at least one animated object with the still image.

5. The method as claimed in claim 4, wherein the animated object comprises at least a 2-dimensional object, a 3-dimensional object, or a video object.

6. The method as claimed in claim 1, wherein the animated image comprises a slideshow derived from the still image associated with at least one transition effect.

7. The method as claimed in claim 1, the animated image presentation data comprises image sequence.

8. The method as claimed in claim 1, wherein the animated image presentation data comprises at least one image object derived from the still image and presentation code stating the way to present the image object, such that presentation of the image object according to the presentation code implements display of the animated image.

9. The method as claimed in claim 8, wherein the animated image presentation data comprises metadata of the at least one still image, and the animated image is presented by displaying the still image and continuously varying the still image with respect to at least one attribute stored in the metadata.

10. The method as claimed in claim 1, wherein the menu foreground element providing step further comprises the step of providing a menu template comprising the menu foreground elements.

11. The method as claimed in claim 1, wherein the animated image and animated image presentation data generating step are performed automatically.

12. The method as claimed in claim 1, wherein the animated image and animated image presentation data generating step requires adjustable parameter settings.

13. The method as claimed in claim 1, further comprising a step of providing predetermined option settings required by the animated image and animated image presentation data generating step.

14. The method as claimed in claim 1, wherein the media format comprises a disc format.

15. A machine-readable storage medium storing a computer program which, when executed, directs a computer to perform a motion menu generation method as claimed in claim 1.

16. A motion menu generation system, comprising:
a foreground authoring module providing menu foreground elements;
a background authoring module retrieving at least one still image, generating an animated image from the still image, and generating animated image presentation data for presenting the animated image; and
a menu generation module generating a motion menu comprising the menu foreground elements and a background for displaying the animated image according to the animated image presentation data, wherein the motion menu conforms to a media format.

17. The system as claimed in claim 16, wherein the animated image implements at least one image effect on the still image.

18. The system as claimed in claim 16, wherein the image effect comprises at least a Oil Paint, Light, Colored Pen, Bubble, Brightness & Contrast, Pan & Zoom, Star, Water Color, Diffuse Glow, Zoom Motion, Lens Flare, Charcoal, or a Mosaic effect.

19. The system as claimed in claim 16, wherein the animated image is derived by combining at least one animated object with the still image.

20. The system as claimed in claim 19, wherein the animated object comprises at least a 2-dimensional object, a 3-dimensional object, or a video object.

21. The system as claimed in claim 16, wherein the animated image comprises a slideshow derived from the still image associated with at least one transition effect.

22. The system as claimed in claim 16, wherein the animated image presentation data comprises an image sequence.

23. The system as claimed in claim 16, wherein the animated image presentation data comprises at least one image object and presentation code directing presentation of the image object, such that presentation of the image object according to the presentation code implements display of the animated image.

24. The system as claimed in claim 23, wherein the animated image presentation data comprises metadata of the at least one still image, and the animated image is presented by displaying the still image and continuously varying the still image with respect to at least one attribute stored in the metadata.

25. The system as claimed in claim 16, wherein the background authoring module automatically generates the animated image and the animated image presentation data.
